(19) United States
(12) Patent Application Publication
(10) Pub. No.: US 2011/0010949 A1
(43) Pub. Date: Jan. 20, 2011

(54) Tactical Knife Capable of Trapping and Cutting an Opponent's Limb

(76) Inventor: Craig Garrison, Placerville, CA (US)

Correspondence Address: Morgan Law Offices, PLC, 4635 S. Lakeshore Dr. Suite 131, Tempe, AZ, 85282, US

(21) Appl. No.: 12/505,104

(22) Filed: Jul. 17, 2009

(51) Int. Cl. B26B 3/04

(52) U.S. Cl. 30/279.2; 30/303

(57) ABSTRACT

An improved tactical knife comprises a first portion, including a pair of substantially identical projections, each one of the pair of substantially identical projections including a left sharpened curved side and a right sharpened curved side, the left sharpened curved side and the right sharpened curved side of each projection meeting to form a respective piercing point. Preferably, the first portion is structured and arranged such that an area between the projections forms a trap sufficient to hold and immobilize a human limb. The improved tactical knife further comprises a second portion, including a handle for holding the knife and a third portion, including a guard for preventing slippage, the third portion situate between the first portion and the second portion. Preferably, the area between the projections includes a separate, inwardly curved edge for cutting the human limb trapped therein.

### FIELD OF THE INVENTION

The present invention relates to an improved tactical knife configured with a pair of piercing points and five cutting edges that offers improved offensive and defensive knife fighting capabilities including the ability to trap and cut an opponent's limb.

### BACKGROUND

A typical tactical knife employs a double-edged blade used to “cut and thrust” against an opponent at close range. Innovation in the design of these “stabbing weapons” has tended to be limited to the materials used to construct the knife, ergonomics (such as the grip being comfortable), slight variations in blade shape, and the ornamental aspects of the knife. Indeed, many tactical knives (i.e., “fighting knives”) are mere variation of dagger designs dating to the Middle Ages or the Bowie knife introduced in the early 19^{th} Century. An example of a contemporary Bowie-style knife is the USMC-issue KA-BAR fighting knife.

Because tactical knife designs have not changed very much over the years, neither has knife fighting techniques using these knives. While instructors teach students to recognize all possible options and to select the most feasible in the particular situation, these various options are limited by the weapon that the defender is holding at the moment. Conventional knives cannot “encircle” a wrist, arm, or throat. Furthermore, conventional knives have only one point with which to puncture an adversary. Moreover, established blade-handling training teaches use of a tactical knife to “enlarge the wound”. This isn't a pretty proposition, but because conventional knives tend to produce relatively clean wounds, it requires twisting the knife after it is inserted and “ripping” it out as opposed to just retracting it.

Various other types of “cutting” weapons have been employed over the ages but, generally, lack the qualities that make fighting knives most attractive. Swords are difficult to conceal and hard to maneuver. Many other types of martial arts weapons have been developed but tend to be cumbersome. Interestingly, it has been reported that at one time groups of Gypsies employed sharpened scissors to fight. Although apparently highly effective, fighting techniques using sharpened scissors appear to have been lost to history.

Accordingly, there is a need for an improved tactical knife with a functional design that would offer both improved offensive and defensive knife fighting capabilities and overcome the deficiencies noted above.

### SUMMARY OF THE INVENTION

In accordance with a preferred embodiment of the present invention, an improved tactical knife is provided. The improved tactical knife comprises a first portion, including a pair of substantially identical projections, each one of the pair of substantially identical projections including a left sharpened curved side and a right sharpened curved side, the left sharpened curved side and the right sharpened curved side of each projection meeting to form a respective piercing point. Preferably, the first portion is structured such that an area between the projections forms a trap sufficient to hold and immobilize a human limb. The improved tactical knife further comprises a second portion, including a handle for holding the knife and a third portion, including a guard for preventing slippage, the third portion situate between the first portion and the second portion.

Preferably, the area between the projections includes an inwardly curved edge for cutting the human limb trapped therein. Preferably, the human limb can be trapped when the limb is held within the area between the projections and the piercing points are simultaneously pressed against an object. The limb may also be trapped by securing the limb within the area between the projections and holding the limb against the opponent's body or such that movement of the limb away is painful or practically impossible.

Preferably, the distance between the piercing points is at least four inches and no more than six inches. Preferably, the tactical knife is between six and twelve inches in length and has a thickness of less than one-quarter inch. Preferably, the tactical knife is flat, symmetrical, and constructed substantially entirely of stainless steel. Preferably, the handle includes a grip made at least in part from cloth, preferably nylon braid. Alternatively, the handle can be hollow to facilitate placement of a stick in the hollow handle for stabilized throwing, use as a spear-type weapon, extending the reach of the knife, or as a “fighting stick”, etc.

The improved tactical knife is also highly useful as a thrusting weapon. In particular, resistance to penetration is absorbed by the two piercing points and along the cutting edges. The novel configuration of the cutting edges and piercing points enables the user to employ defensive and offensive techniques that were heretofore impossible to perform with a conventional knife.

These and other aspects, features and advantages of the present invention will become apparent from the following detailed description of preferred embodiments, which is to be read in connection with the accompanying drawings.

### BRIEF DESCRIPTION OF THE DRAWINGS

FIG. 1 shows an exemplary tactical knife capable of trapping and cutting an opponent's limb, in accordance with a preferred embodiment of the present invention;

FIG. 2 shows a side view of the exemplary tactical knife of FIG. 1;

FIG. 3 shows the exemplary tactical knife of FIG. 1 in use against an opponent wielding a conventional fighting knife;

FIG. 4 shows exemplary tactical knife of FIG. 1 in use to immobilize an opponent;

FIGS. 5(a) and 5(b) show the exemplary tactical knife of FIG. 1 with an optional hand grip; and

FIGS. 6(a) and 6(b) show an exemplary tactical knife with a hollow handle, according to another preferred embodiment of the present invention.

### DETAILED DESCRIPTION

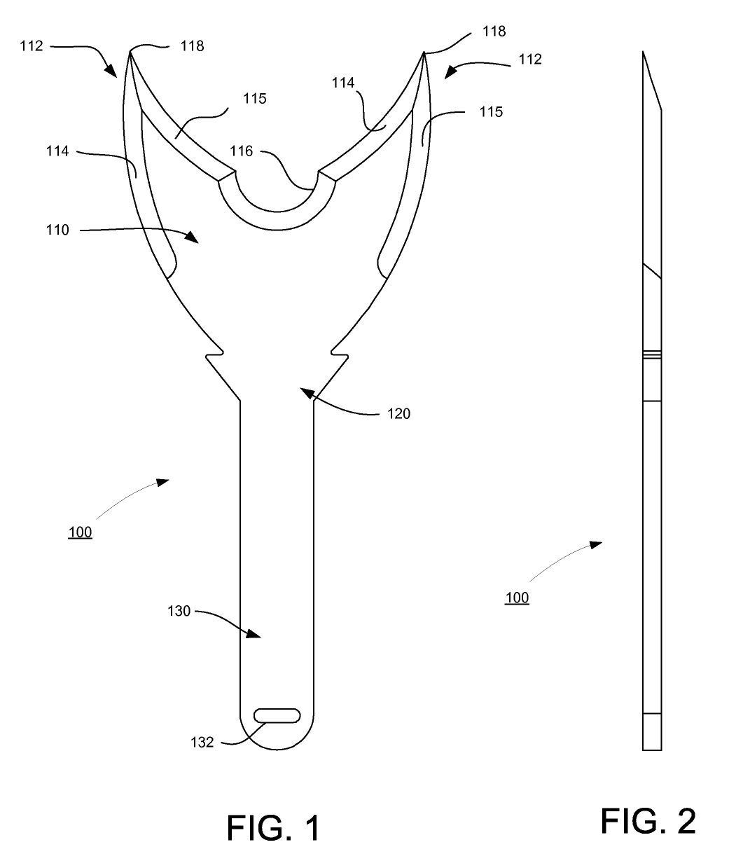

FIG. 1 illustrates an exemplary tactical knife 100 in accordance with a preferred embodiment of the present invention. A side view of the tactical knife 100 is shown in FIG. 2. The tactical knife 100 includes a first portion 110, a second portion 120, and a third portion 130, as shown. The first portion 110 includes a pair of substantially identical projections 112. Preferably, each one of the substantially identical projections 112 includes a left sharpened curved side 114 and a right sharpened curved side 115, as shown. Preferably, the left sharpened curved side 114 and the right sharpened curved side 115 of each projection 112 meet to form a respective piercing point 118, as shown. Accordingly, the tactical knife 100 includes a pair of piercing points 118, as shown.

Preferably, the first portion 100 is structured such that an area between the projections 112 forms a trap sufficient to hold and immobilize a human limb, particularly, the opponent's arm, wrist, neck, or leg. The tactical knife 100 further includes an inwardly curved edge 116 for cutting the human limb trapped therein, as shown. Preferably, the human limb can be trapped when the limb is held within the area between the projections 112 and the piercing points 118 are simultaneously pressed against a fixed object, such as, for example, a wall or door. The human limb may also trapped by securing the limb within the area between the projections 112 and holding the limb against the opponent's body, or such that movement of the limb away would be painful or practically impossible. For example, the user may trap the opponent's arm in the area between the projections 112 and continuously push the opponent's arm in a particular direction until the arm assumes a position in which it can move no farther. Because the knife 100 includes cutting edge 116 for cutting the human limb trapped therein, the opponent should offer little resistance.

The tactical knife 100 is also highly useful as a thrusting weapon. In particular, resistance to penetration is absorbed by the two piercing points 112 and along the various edges. The configuration of the cutting edges 114, 115 and piercing points 112 enables the user to employ defensive and offensive techniques that were impossible to perform with a conventional knife.

Preferably, the distance between the piercing points 112 is at least four inches (10.2 cm) and no more than six inches (15.2 cm). Preferably, the tactical knife 100 is between six and twelve inches (between 15.2 cm and 30.5 cm) and has a thickness less than one-quarter inch (0.6 cm). Preferably, the tactical knife is flat, symmetrical, and constructed substantially entirely of stainless steel.

Preferably, the second portion 120 of the tactical knife 100 includes a handle for holding the tactical knife 100. Preferably, the third portion 120 includes a guard for preventing the user's hand from slipping. Preferably, the handle of the tactical knife 100 also includes a hole 132, as shown, for mounting the knife or for placing a string through it. Preferably, the third portion 130 is situate between the first portion 110 and the second portion 130.

The tactical knife 100 can be manufactured by various known or later developed processes. The tactical knife 100 can be machined from a single sheet of metal (e.g., stainless steel, carbon steel) having an approximate thickness of one-quarter inch (0.6 cm), for example. Alternatively, the tactical knife 100 can be made by forging or stamping. Preferably, the tactical knife 100 is tempered and the blades are further sharpened and polished using various abrasive grinding and polishing tools.

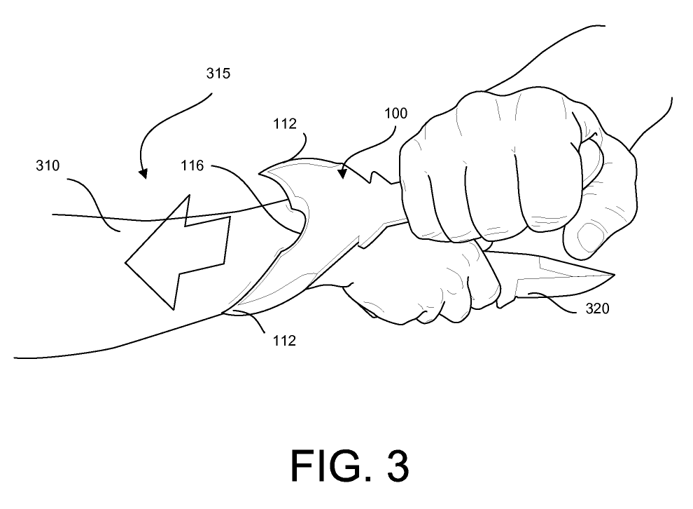

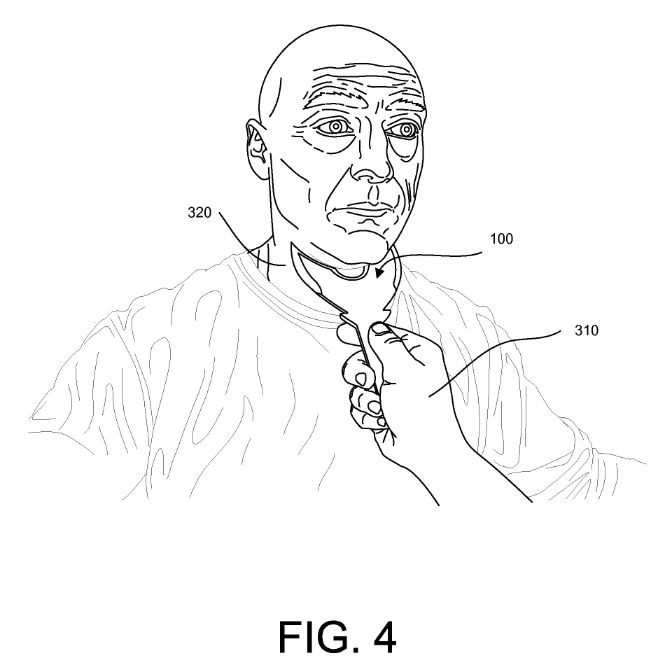

FIG. 3 illustrates the tactical knife 100 in use against an opponent wielding a conventional fighting knife 320. As shown, the opponent's arm 310 is pinned between the piercing points 112. While being trapped in this manner the cutting edge 116 can be used to cut the arm 310, forcing the opponent to drop the conventional knife 320. FIG. 4 illustrates the tactical knife 100 in use to immobilize an opponent by placing the tactical knife 100 upon the opponent's neck 320. In this case, the hand 310 of the user firmly grasps the tactical knife 100 in such a way as to place the opponent's neck 320 within the area between the projections 112. Because the blades in this area, including cutting edge 116, are preferably sharp, the opponent should offer little resistance. However, if the opponent does resist, various large blood vessels along the opponent's neck 320 can be severed by employing the tactical knife to cut the opponent's neck 320.

Although the descriptions and illustrations contained herein show the tactical knife 100 being used in particular ways, it is to be appreciated that these are meant only to provide examples of usage. It is to be appreciated that the tactical knife 100 may be employed defensively to trap a human limb in various other ways and offensively as a thrusting weapon. The piercing points 112 are particularly suitable also as a stabbing weapon. In all cases, however, it is to be understood that the present invention is meant to be used only within the bounds of the law, including, for example, in justified self defense or defense of others, and in combat according to the rules of war.

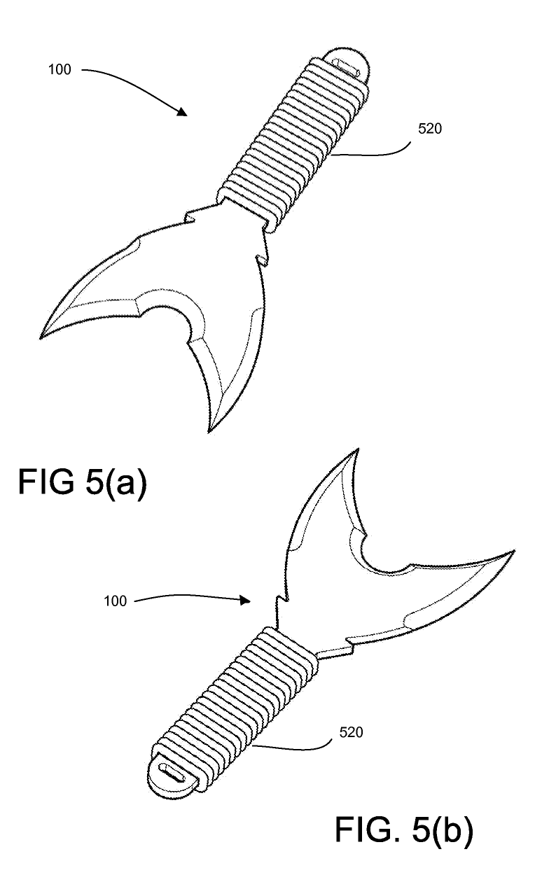

FIGS. 5(a) and 5(b) show the tactical knife 100 with an optional hand grip 520. Preferably, the hand grip 520 is made from nylon cord and wrapped around the handle, as shown. However, it is to be appreciated that the hand grip 520 may be constructed using various other material, including cloth, synthetic rubber, plastic, foam, etc. Preferably, the material selected for the hand grip 520 should provide a firm grip but also absorb forces applied to the tactical knife 100, and be durable.

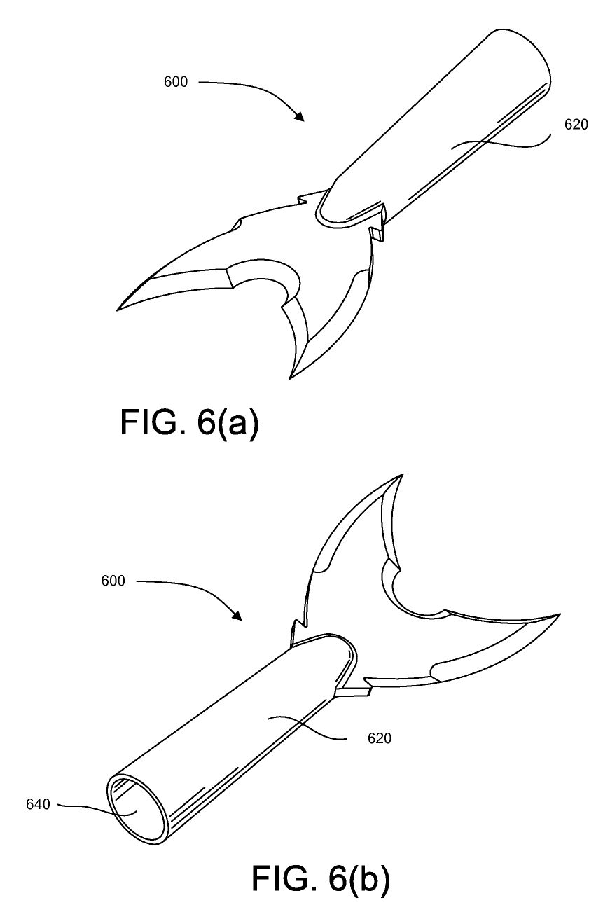

FIGS. 6(a) and 6(b) show a tactical knife 600 with a hollow handle 620, according to another preferred embodiment of the present invention. Preferably, except for the hollow handle 620, the tactical knife 600 is the same, or substantially similar, in all other respects. The hollow handle 620 includes a hollow area 640, as shown. The hollow handle 620 accommodates placement of a wooden stick to facilitate stabilized throwing the tactical knife 600, using the tactical knife 600 as a spear-type weapon, extending the reach of the tactical knife 600, or using the tactical knife 600 as a “fighting stick”. It is to be appreciated that when the tactical knife 600 is employed as a fighting stick, it can be used offensively as a stabbing weapon as well as to trap an opponent's limb, in the manner discussed above.

In a knife fight, it is critical that all options are recognized and the most feasible selected in the particular situation. However, the various options are limited by the weapon that the defender is holding at the moment. While conventional knives cannot “encircle” a wrist, arm, or throat, the present invention provides a knife that can be used to do this. Furthermore, the present invention provides a knife with more than one piercing point, as compared to conventional knives that have only one point with which to puncture an adversary. Moreover, the present invention provides a tactical knife highly suitable for combat situations.

While this invention has been described in conjunction with the various exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. A tactical knife, comprising:
a first portion, including a pair of substantially identical projections, each one of the pair of substantially identical projections including a left sharpened side and a right sharpened side, the left sharpened side and the right sharpened side meeting to form a respective piercing point;
a second portion, including a handle for holding the knife; and
a third portion, including a guard for preventing slippage, the third portion situate between the first portion and the second portion;
wherein the first portion is structured and arranged such that an area between the pair of substantially identical projections forms a trap sufficient to hold and immobilize a human limb.

2. The tactical knife of claim 1, wherein the area between the piercing points includes an inwardly curved edge.

3. The tactical knife of claim 2, wherein the inwardly curved edge is a sharpened for cutting the human limb.

4. The tactical knife of claim 1, wherein the trap is formed when the piercing points are simultaneously pressed against an object.

5. The tactical knife of claim 1, wherein the distance between the piercing points of the pair of piercing elements is at least four inches.

6. The tactical knife of claim 1, wherein the distance between the piercing points of the pair of piercing elements is no more than six inches.

7. The tactical knife of claim 1, wherein the tactical knife is constructed substantially entirely of stainless steel.

8. The tactical knife of claim 1, wherein the handle includes a grip made at least in part from nylon braid.

9. The tactical knife of claim 1, wherein the length of the knife is between 6 and 12 inches.

10. The tactical knife of claim 9, wherein the thickness of the knife is less than one-quarter inch.

11. The tactical knife of claim 1, wherein the handle is flat.

12. The tactical knife of claim 1, wherein the handle is hollow.

13. The tactical knife of claim 1, wherein each left sharpened side and right sharpened side of each of the pair of piercing elements is curved.

14. The tactical knife of claim 1, wherein the knife is symmetrically shaped.
